(19) United States
(12) Patent Application Publication
(10) Pub. No.: US 2015/0276956 A1
(43) Pub. Date: Oct. 1, 2015

(54) WAVE-EQUATION BASED PROCESSING AND ANALYSIS OF IMAGED SEISMIC DATA

(71) Applicant: CGG SERVICES SA, Massy Cedex (FR)

(72) Inventors: Adel KHALIL, Aberdeen (GB); Henning HOEBER, East Grinstead (GB)

(21) Appl. No.: 14/670,553

(22) Filed: Mar. 27, 2015

Related U.S. Application Data
(60) Provisional application No. 62/089,431, filed on Dec. 9, 2014.
(60) Provisional application No. 61/971,567, filed on Mar. 28, 2014.

(51) Int. Cl. G01V 1/36; G01V 1/38

(52) U.S. Cl. CPC G01V 1/36; G01V 1/38; G01V 2210/51; G01V 2210/74

(57) ABSTRACT

A device, medium and method for processing seismic data associated with a subsurface of the earth. The method includes a step of receiving seismic data (d) recorded with one or more seismic receivers; a step of processing the seismic data (d) with a first processing algorithm to obtain imaged seismic data (D); a step of constructing wave-fields (W) corresponding to the imaged seismic data (D) by solving a given wave equation, wherein the wave-fields (W) have an added axis (τ) which maps back spectral properties of the imaged seismic data to its pre-imaging state; and a step of processing the wave-fields (W) along the axis (τ) with a second processing algorithm.

### CROSS REFERENCE TO RELATED APPLICATIONS

The present application claims the benefit of priority under 35 U.S.C. §119(e) to U.S. Provisional Application No. 61/971,567 filed on Mar. 28, 2014, and U.S. Provisional Application No. 62/089,431 filed on Dec. 9, 2014, the entire contents of which is hereby incorporated by reference.

### BACKGROUND

1. Technical Field

Embodiments of the subject matter disclosed herein generally relate to methods and systems for processing seismic data and, more particularly, to mechanisms and techniques for producing improved processing and analysis tools for imaged seismic data with complex and dipping geological structures.

2. Discussion of the Background

Seismic data acquisition and processing may be used to generate a profile (image) of geophysical structures under the ground (subsurface). While this profile does not provide an accurate location for oil and gas reservoirs, it suggests, to those trained in the field, the presence or absence of such reservoirs. Thus, providing a high-resolution image of the subsurface is important, for example, to those who need to determine where oil and gas reservoirs are located.

Reverse time migration (RTM) is one migration technique for processing recorded seismic data. RTM conventionally uses the acoustic wave equation with constant density and variable-velocity. The spatially variable velocity field may include high contrasts that introduce undesired reflections. These reflections create low-frequency artifacts when forming the image of the surveyed subsurface. For generating the image, 3D angle gathers are generated using RTM, which is a costly process. Far-field approximations are often used to reduce the cost, but may fail for complex wave-fields and generally require explicit dip information.

As noted above, the acoustic wave equation that drives RTM usually assumes that the propagation medium has only velocity variations, whereas the density is presumed constant. Sharp velocity contrasts such as salt and chalk boundaries introduce undesired reflections which can create the low-frequency artifacts when applying the imaging condition. Many methods have been devised to attenuate these artifacts. Some methods are based on wave-fields decomposition, some are applied on the post-stack image, and others use modified imaging conditions.

However, none of these methods remove the fundamental source of the problem; they only try to remove its effect. Thus, there is a need to develop a method capable of processing recorded seismic data while overcoming the above-noted limitations.

### SUMMARY OF THE INVENTION

According to an embodiment, there is a method for processing seismic data associated with a subsurface of the earth. The method includes a step of receiving seismic data (d) recorded with one or more seismic receivers; a step of processing the seismic data (d) with a first processing algorithm to obtain imaged seismic data (D); a step of constructing wave-fields (W) corresponding to the imaged seismic data (D) by solving a given wave equation, wherein the wave-fields (W) have an added axis (τ) which maps back spectral properties of the imaged seismic data to its pre-imaging state; and a step of processing the wave-fields (W) along the axis (τ) with a second processing algorithm.

According to another embodiment, there is a method for processing seismic data associated with a subsurface of the earth. The method includes a step of receiving imaged seismic data, wherein the imaged seismic data is obtained by processing recorded seismic data (d) with a first processing algorithm; a step of constructing wave-fields (W) corresponding to the imaged seismic data (D) by solving a given wave equation, wherein the wave-fields (W) have an added axis (τ) which maps back spectral properties of the imaged seismic data to its pre-imaging state; and a step of processing the wave-fields (W) along the axis (τ).

According to yet another embodiment, there is a computing system for processing seismic data associated with a subsurface of the earth. The computing device includes an interface for receiving seismic data (d) recorded with one or more seismic receivers; and a processor connected to the interface. The processor is configured to process the seismic data (d) with a first processing algorithm to obtain imaged seismic data (D), construct wave-fields (W) corresponding to the imaged seismic data (D) by solving a given wave equation, wherein the wave-fields (W) have an added axis (τ) which maps back spectral properties of the imaged seismic data to its pre-imaging state, and process the wave-fields (W) along the axis (τ) with a second processing algorithm.

According to still another exemplary embodiment, there is a computer-readable medium including computer executable instructions, wherein the instructions, when executed by a processor, are implemented to process seismic data associated with a subsurface of the earth. The instructions implement the method steps discussed above.

### BRIEF DESCRIPTION OF THE DRAWINGS

For a more complete understanding of the present invention, reference is now made to the following descriptions taken in conjunction with the accompanying drawings, in which:

FIG. 1 illustrates a marine seismic survey system;

FIG. 2 illustrates a two-layer model;

FIGS. 3A-D illustrate snapshots of the wave-field after passing from one layer to another layer;

FIG. 4A shows a base dataset while FIG. 4B shows a monitor dataset; FIG. 4C shows estimated normal displacements; FIG. 4D shows the difference between the base and monitor datasets, and FIG. 4E shows the difference after applying the estimated shifts;

FIG. 5 schematically shows the wavelets for a simple dipping event before imaging, while FIG. 6 shows the same wavelets after imaging;

FIG. 7 shows a dipping reflector and the direction of the orthogonal time τ, while FIG. 8 shows the corresponding gather along the orthogonal time axis;

FIG. 9A shows two wavelets obtained with a conventional 1D convolution, while FIG. 9B shows the two wavelets extracted along the orthogonal time axis;

FIGS. 10A-B show a comparison between the traditional elastic inversion and a novel elastic inversion;

FIG. 11 is a flowchart of a method for processing seismic data based on a wave equation;

FIG. 12 is a flowchart of another method for processing seismic data based on a wave equation;

FIG. 13 is a flowchart of still another method for processing seismic data based on a wave equation;

FIG. 14 is a flowchart of a method for processing seismic data; and

FIG. 15 is a schematic diagram of a computing device that implements a method for processing seismic data.

### DETAILED DESCRIPTION OF THE INVENTION

The following description of the exemplary embodiments refers to the accompanying drawings. The same reference numbers in different drawings identify the same or similar elements. The following detailed description does not limit the invention. Instead, the scope of the invention is defined by the appended claims. The embodiments to be discussed next are not limited to a specific migration algorithm, but may be applied to any migration algorithm or processing method.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an exemplary embodiment, there is a method for processing seismic data associated with a subsurface of the earth. The method includes receiving seismic data (d) recorded with one or more seismic receivers; processing the seismic data (d) with a first processing algorithm to obtain imaged seismic data (D); constructing one or more wave-fields (W) corresponding to the imaged seismic data (D) by solving a given wave equation wherein the wave-fields (W) have an added axis (τ) which is orthogonal to the wave-fronts that encompass imaged reflectors; and processing the wave-fields (W) along the axis (τ) with a second processing algorithm. More details about these steps are discussed in the following embodiments.

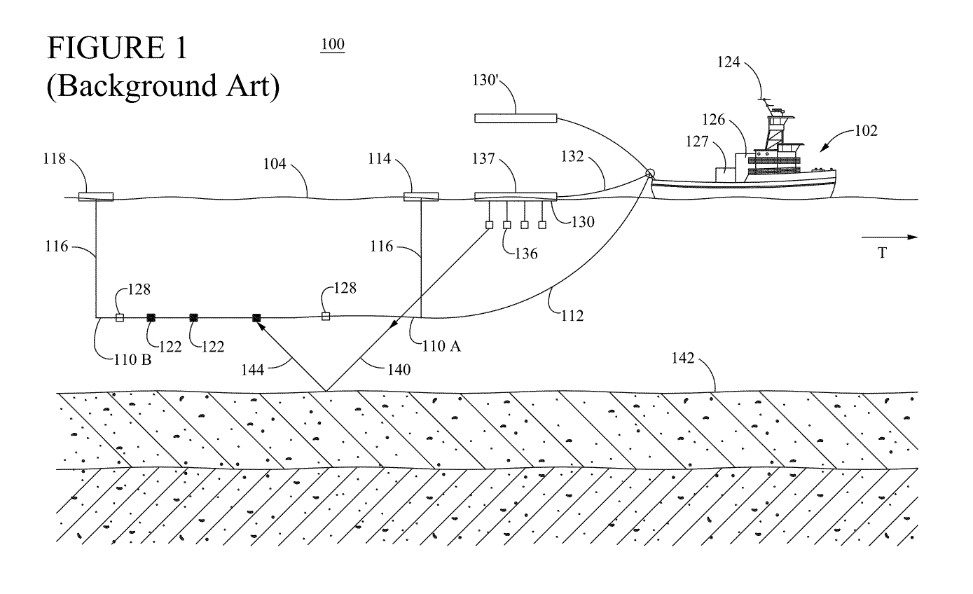

Prior to discussing the details of this method, it is believed to be in order to describe one marine seismic acquisition system 100. While FIG. 1 shows a marine seismic acquisition system, the processing methods discussed herein may be applied to seismic data collected with a land seismic acquisition system or any other acquisition system.

The marine seismic acquisition system 100 includes, as illustrated in FIG. 1, a vessel 102 that tows plural streamers 110 (only one is visible in the figure) and a seismic source array 130. Streamer 110 is attached through a lead-in cable (or other cables) 112 to vessel 102, while source array 130 is attached through an umbilical 132 to the vessel. A head float 114, which floats at the water surface 104, is connected through a cable 116 to the head end 110A of streamer 110, while a tail buoy 118 is connected, through a similar cable 116, to the tail end 1108 of streamer 110. Head float 114 and tail buoy 118 are used, among other things, to maintain the streamer's depth. Seismic sensors 122 are distributed along the streamer and configured to record seismic data. Seismic sensors 122 may include a hydrophone, geophone, accelerometer or a combination thereof. Positioning devices 128 are attached along the streamer and controlled by a controller 126 for adjusting a position of the streamer according to a survey plan.

Source array 130 has plural source elements 136, which are typically air guns. The source elements are attached to a float 137 to travel at desired depths below the water surface 104. The source elements attached to float 137 form a sub-array. Source array 130 may have multiple sub-arrays, typically three. Traditionally, vessel 102 tows two source arrays 130 and 130′, which may be identical. During operation, vessel 102 follows a predetermined path T while source elements (usually air guns) 136 emit seismic waves 140. These waves bounce off the ocean bottom 142 and other layer interfaces below the ocean bottom 142 and propagate as reflected/refracted waves 144, which are recorded by sensors 122. The positions of both source elements 136 and recording sensors 122 may be estimated based on GPS systems 124 and recorded together with the seismic data in a storage device 127 onboard the vessel. Controller 126 has access to the seismic data and may be used to achieve quality control or even fully process the data. Controller 126 may also be connected to the vessel's navigation system and other elements of the seismic survey system, e.g., positioning devices 128.

From the recorded seismic data, various gathers may be generated using a processing method. One type of gathers that provides valuable information about the subsurface is three-dimensional (3D) angle gathers. These gathers are known in the art and, for this reason, they are not discussed herein. However, generating these gathers is challenging, as discussed in the Background section.

The 3D angle gathers may be used to drive tomographic velocity updates and deliver key reservoir attributes such as fracture orientation. In complex geology, RTM gives the most reliable image of the subsurface. Generating 3D angle gathers from RTM can be computationally intensive, as is known by those skilled in the art. Most methods rely on far-field approximation to reduce the cost, while others require explicit structural dip information.

The novel approach to be discussed herein relies on the Dirac equation, which describes spin-½ particles in physics. The equation is derived from the relativistic Energy-Momentum conservation relation, which greatly resembles the acoustic wave equation. A wave-field that satisfies the Dirac equation is defined as a dual component vector, and the acoustic wave equation is factorized as now discussed.

The new factorized wave equation is nonreflecting at normal incidence. Moreover, non-normal reflections are separated from transmitted energy into the two different components of the vector wave-field. A cross-correlation imaging condition is then generalized to incorporate the vector nature of the source and receiver wave-fields. Low-frequency artifacts are then effectively attenuated.

The new wave equation also allows for calculation of the wave-field propagation direction through the use of simple inner products of the vector wave-fields. The calculated propagation direction is exact, does not involve far-field approximations, and is therefore stable.

Turning now to the new wave equation, it is noted that the traditional constant density acoustic wave equation is given by:

$$( Δ - \frac{1}{{c ( x )}^{2}} {\partial }_{t}^{2} ) p ( x ; t ) = 0 , \qquad ( 1 )$$

where x is the spatial coordinate vector, t is time, p is the wave-field, c is the spatially variable medium velocity and Δ is the Laplacian operator.

Factorizing equation (1) requires finding the square root of the Laplacian operator, which is often a very complex task and requires some form of series approximation. In this equation, p is defined as a dual-component vector that will be discussed later. The problem is then linearized and becomes simpler.

The square root of the Laplacian can be stated as:

$$p = ( \begin{matrix}{p}_{+} \\ {p}_{-}\end{matrix} ) , \qquad ( 2 )$$

where p₊ and p₋ are the two components of wave-field p. The square root of the Laplacian can be stated as:

Δ=(σ,∇)(σ,∇), (3)

where

σ·∇=σₓ∂ₓ+σ_{y}∂_{y}+σ_{z}∂_{z}, (4)

and σₓ, σ_{y}, and σ_{z} are the Pauli matrices given by

$${σ}_{x} = ( \begin{matrix}0 & 1 \\ 1 & 0\end{matrix} ) , {σ}_{y} = ( \begin{matrix}0 & - i \\ i & 0\end{matrix} ) , {σ}_{z} = ( \begin{matrix}1 & 0 \\ 0 & - 1\end{matrix} ) . \qquad ( 5 )$$

Substituting equations (2), (3) and (4) into equation (1), the following equation is obtained:

$$( I \frac{1}{c} {\partial }_{t} - σ \cdot ▽ ) ( I \frac{1}{c} {\partial }_{t} + σ \cdot ▽ ) p = - ( σ \cdot \frac{▽ c}{c} ) \frac{1}{c} {\partial }_{t} p , \qquad ( 6 )$$

where I is the unity matrix.

The right-hand side of equation (6) involves only the spatial derivative of the velocity function and, therefore, this part is interpreted herein as corresponding to a reflectivity operator.

According to an embodiment, the reflectivity operator is set to zero to remove spurious reflections. By decoupling equation (6), the factorized wave equation is realized as:

$$( I \frac{1}{c} {\partial }_{t} \pm σ \cdot ▽ ) p = 0 , \qquad ( 7 )$$

where the +/− sign indicates that there actually two different equations.

First-order equations are generally more difficult to solve and less stable than second-order ones. In this respect, note that equation (6) is a second-order equation, while equations (7) are first-order equations. A second-order equation needs two initial conditions to be solved, while a first-order equation needs only one initial condition. However, by making a few substitutions and rearrangements, equations (7) are reformed in a second-order structure as follows:

$$( Δ - \frac{1}{{c}^{2}} {\partial }_{t}^{2} ) p = - ( σ \cdot \frac{∇ c}{c} ) ( σ \cdot ∇ ) p . \qquad ( 8 )$$

The form of equation (8) is similar to that of equation (1) except for the right-hand side term, which couples the two wave-fields components p₊ and p₋. This term is related to remapping velocity-related reflections and redistributing energy between the two components. Two controlling factors in this term of equation (8) are the velocity gradient and the wave-field directional derivative given by σ·∇p. Effectively, these factors govern the direction of wave-field propagation.

The Pauli matrices defined in equation (5) are the coefficients used to define the square root of the Laplacian operator. Equation (4) is written in the form of an inner-product of the gradient operator with the Pauli vector. These matrices act as the vector basis that defines the space.

This observation suggests that the components uₓ, u_{y}, and u_{z} of the propagation direction of the wave-field can be computed by forming inner-products using the Pauli matrices as follows:

$${u}_{x} = \frac{{p}^{H} {σ}_{x} p}{{p}^{H} p} , {u}_{y} = \frac{{p}^{H} {σ}_{y} p}{{p}^{H} p} , {u}_{z} = \frac{{p}^{H} {σ}_{z} p}{{p}^{H} p} , \qquad ( 9 )$$

where superscript H means the complex conjugate operation.

Using equation (8) in an RTM setting requires the injection of recorded seismic data as boundary values and defining an appropriate imaging condition.

The recorded seismic traces d have to be preprocessed by projecting them onto the eigenspace of the wave equation operator of equation (7)

$$d ( x , y ; ω ) = \frac{1}{{( 2 π )}^{2}} \int d {k}_{x} d {k}_{y} {e}^{i ( {k}_{x} x + {k}_{y} y )} Ψ ( {k}_{x} , {k}_{y} ; ω ) \times d ( {k}_{x} , {k}_{y} ; ω ) , \qquad ( 10 )$$

where ω is the angular frequency, kₓ and k_{y} are the spatial wave-numbers and Ψ is the eigenvector. One possible definition for Ψ is given by:

$$Ψ ( {k}_{x} , {k}_{y} ; ω ) = \frac{v}{‖ v ‖} , v = ( \frac{\begin{matrix}1 \\ - {k}_{x} - {ik}_{y}\end{matrix}}{{k}_{t} + \vert {k}_{z} \vert} ) , {k}_{t} = \frac{ω}{{c}_{z = 0}} . \qquad ( 11 )$$

While more sophisticated imaging conditions can be developed for equation (8), this embodiment only shows a simple generalization of the cross-correlation imaging condition, which is given by:

I(x)=∫pₛ^{H}(x,t)×pᵣ(x,t)dt, (12)

where pₛ and pᵣ are the forward/backward propagated source and receiver wave-fields and I(x) is the formed image.

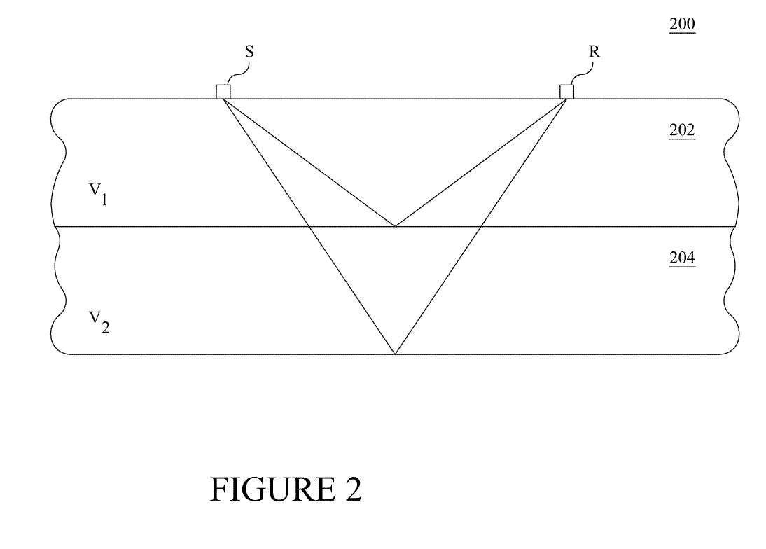

The above-discussed new equation (8) and cross-correlation imaging condition (12) are now applied to a simple model for validation. This simple model is the two-layer model 200 illustrated in FIG. 2, i.e., a substrate that is considered to have only two layers 202 and 204. The velocity v₁ of the top layer 202 of the model is assumed to be 2,000 m/s, and the velocity v₂ of the bottom layer 204 is assumed to be 4,000 m/s. In this example, the results obtained with (i) the conventional constant density wave equation (1) and those obtained with (ii) the constant impedance wave equation are compared with (iii) the results produced with the two-way nonreflecting wave equation, which is the factorized directional wave equation (8).

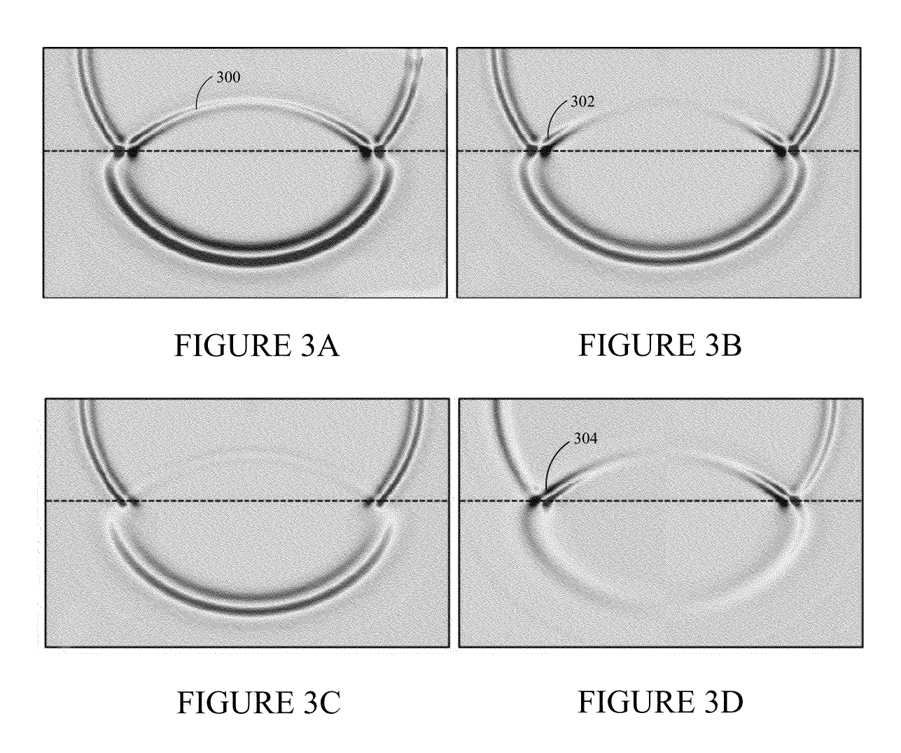

FIGS. 3A-D show a snapshot of the wave-field after passing through the interface between layers 202 and 204. FIG. 3A shows the results obtained with the constant density wave equation, FIG. 3B shows the results obtained with the constant impedance wave equation, FIG. 3C shows the first component p₊ of the factorized equation (8) and FIG. 3D shows the second component p₋ of the factorized equation (9).

The constant density wave equation produces reflections at all incidence angles as illustrated by 300 in FIG. 3A, while the constant impedance wave equation annihilates reflections at normal incidence, leaving reflections 302 at angles different from zero, as shown in FIG. 3B. Examining the first component (p₊) of the solution of the factorized directional wave equation represented in FIG. 3C, it is observed that this solution significantly attenuates reflections at a much wider range than the constant impedance solution. It is also observed that the non-normal reflections 304 have been mapped to the second component (p₋) of the wave-field in FIG. 3D. Similar improvements are observed for the shot calculated with the new equation (8) and the imaging condition (12). Thus, these equations advantageously remove low-frequency artifacts. These equations also show improved stability and accuracy in extracting directional information, especially when using equation (9). The exact solution calculated with these equations is robust even in the presence of conflicting energies or complex multi-arrivals.

Thus, according to an embodiment, this wave equation helps in reducing RTM's low-frequency artifacts. Furthermore, the propagation direction can be easily computed, and it is more reliable than the commonly used Poynting vectors.

Equations (7) and (8) introduced above and the formalism using Pauli matrices and Dirac equation may be applied to other processing algorithms used in seismic data processing, not only RTM. For example, according to an embodiment that is now discussed, it is possible to calculate image warping (e.g., stretching one set of seismic data to match a second set of seismic data for comparison purposes) based on equation (8).

Now a related but independent concept is discussed. In seismic processing and reservoir characterization, there is often the need to measure relative displacements between different realizations of the seismic data. Over the years, many methods have been developed using different measures of similarity. Such alignment or warping methods are often effective signal- or image-processing tools. However, none of the available methods are directly driven by the physics behind the seismic imaging. As noted above, it can be shown that a seismic image (e.g., migrated seismic data is called seismic image or imaged seismic data) can be associated with a wave-field governed by a wave equation. The different image realizations (e.g., images calculated for base and monitor surveys) can be visualized as snapshots of the wave-field at different times, and this approach conveys the required displacements or time-shifts. By formulating the problem in a physical context, displacements that honor the directionality of the wave propagation are obtained.

For example, 4D time-shifts on migrated stacks are obtained in a direction normal to the reflectors. These shifts are computed in an inverted finite-difference scheme. To overcome limitations of the two-way wave equation in this application, the equation is factorized to its one-way counterparts. The method is demonstrated on synthetic and real datasets.

Throughout the seismic processing sequence, and for reservoir analysis, relative shifts between different datasets are frequently needed. These shifts can be calculated pre-imaging, for example, to reduce the acquisition footprint, or post-imaging, for example, to derive trim-statics. Measuring relative displacements between different data realizations is particularly important in time-lapse processing where time-shifts (often called time-strains) may highlight production-related changes within the reservoir. Over the years, many methods have been developed, often using local cross-correlations or other similarity-based methods. In its different forms, warping is a useful tool to estimate these relative displacements.

The resulting displacement fields may not be unique, and inverting for geologically induced changes can be difficult. In this embodiment, a seismic image (D) can be considered to be associated with a wave-field following a governing wave equation, e.g., equation (8). Note that seismic image (D) is obtained from recorded seismic data (d) after a first processing algorithm is applied. The first processing algorithm may include, for instance, migration. Different image realizations, for example, base and monitor datasets, are visualized as snapshots of a single wave-field at different time steps. Spatially varying time-shifts can be then computed in an inverted finite-difference scheme where the wave-field is fully known, but the step value is not.

To estimate the wave-field at a given time, the two-way wave equation requires at least the knowledge of the wave-field at the two preceding time-steps. This is not readily available in an image-warping context. Thus, this issue is avoided by factorizing the two-way wave equation into its one-way counterparts.

Returning to RTM, which is a useful imaging tool particularly in complex geologies, one of its limitations is that producing angle gathers is not straightforward. A relationship that couples the reflection-angle to the temporal frequency, image wave-number, and the medium velocity is as follows:

$$\frac{4 {cos}^{2} ( θ )}{{c}^{2} ( \underline{x} )} {ω}^{2} = {\vert \underline{k} \vert}^{2} , \qquad ( 13 )$$

where x=(x,y,z) is the space coordinate vector, c(x) is the velocity of the medium, θ is the reflection angle between the source and the receiver wave-fields, w is the angular frequency, and k=(kₓ,k_{y},k_{z}) is the wave-number vector of the imaged data.

Equation (13) may be derived using purely geometrical consideration of source and receiver wave-fields and is applicable in many contexts different from RTM angle gather generation; for example, it may be used to remove RTM low-frequency artifacts. This relationship also holds for other migration methods, such as Kirchhoff migration.

If equation (13) is considered in a domain where the reflection angle is stationary, i.e., a common reflection angle section, the relationship readily translates into a dispersion relation for a new wave equation,

$$\frac{1}{{v}_{θ}^{2} ( \underline{x} )} {\partial }_{t}^{2} {p}_{θ} ( \underline{x} ; t ) = {∇}^{2} {p}_{θ} ( \underline{x} ; t ) , \qquad ( 14 )$$

where t is the time coordinate, p_{θ} represents the wave-field representing the seismic image at one reflection angle, ∇² is the Laplacian operator and v_{θ}(x) is given by:

$${v}_{θ} ( \underline{x} ) = \frac{1}{2} \frac{c ( \underline{x} )}{cos ( θ )} . \qquad ( 15 )$$

Equation (14) shows that a seismic image from a constant angle section is the solution of a wave equation, where the “velocity” is half of the original medium velocity divided by the cosine of the reflection angle. The half factor is associated with the use of two-way time, while the cosine factor represents the migration stretch. An alternative heuristic derivation of equation (14) using the cross-correlation imaging condition is presented later.

Equation (14) is a second-order equation with respect to time. Thus, its solution requires the knowledge of the initial state of the wave-fields and its temporal derivative. This information is generally not readily available within the context of image-warping. Practically, this manifests in the inability of the equation to discriminate between positive and negative shifts without external information. To overcome this issue, equation (14) is factorized to its one-way counterparts. The technique based on the Dirac equation used above with regard to equations (7) and (8) is applied to equation (14). To simplify the notation, the spatial, temporal and angle dependency are dropped to arrive at equation (16),

$$\frac{1}{v} {\partial }_{t} p = \pm σ \cdot ∇ p , \qquad ( 16 )$$

where σ is the Pauli vector and σ·∇ is the square root of the Laplacian operator, i.e., the Dirac operator. The derivation of equation (16) and the structure of the Pauli vector have been discussed above with regard to equation (7) and, thus, are not repeated herein.

The bold notation of the image wave-field p in equation (16) denotes that this wave-field is now considered a dual-component complex vector, in a quantum mechanical context defined as a spinor. To relate the observed image wave-field p to the spinor space, the wave-field is projected onto the eigenspace of the Dirac operator:

p=K[p], (17)

where K is the eigenspace projection operator; this operator and the eigenvectors are defined later.

Equation (16) is first-order in time, and a simple finite difference discretization scheme may be defined as:

$$\begin{matrix}\frac{1}{v} \frac{δ p}{Δ t} = \pm σ \cdot ∇ p , and & ( 18 ) \\ δ p = {p}_{\pm Δ t} - p , & ( 19 )\end{matrix}$$

where p_{+Δt} is the image wave-field propagated for a duration of ±Δt. The choice of sign is arbitrary and is only a matter of convenience. For example, p can be considered to correspond/describe the image of seismic data associated with a base survey, and p_{±Δt} may be considered to correspond/describe the image of seismic data associated with a monitor survey. In another embodiment, both p and p_{±Δt} represent images associated with monitor surveys taken at different times. In this context, ±Δt represents the time interval between the two considered seismic surveys.

In the context of image-warping, the spatially variable time-shift Δt is of interest rather than the propagating wave-fields, as in the embodiment of equation (8). To compute the spatially time-shift Δt, equation (18) is rearranged and a least-squares solution is found to be given by:

$$Δ t = \frac{1}{v} ℜ [ \frac{\pm {( σ \cdot ∇ p )}^{H} ( δ p )}{{( σ \cdot ∇ p )}^{H} ( σ \cdot ∇ p ) + {ɛ}^{2}} ] , \qquad ( 20 )$$

where ε² is white noise to avoid zero divisions, and [symbol] extracts the real component of the solution. Note that the time-shift is spatially varying, i.e., Δt=Δt(x).

To estimate the time-shift between two datasets, the two images (or imaged seismic data D) are injected into p and p_{±Δt} using equation (17). The two injected datasets may be imaged seismic data realizations, e.g., angle stacks for trim-statics estimation leading to improved focusing or, in a time-lapse context, base and monitor images leading to a 4D time-shift volume. The extracted shifts are in the direction normal to the wave-field, which better represent reservoir-related changes. This normal shift may also be projected onto its Cartesian components using the relationship:

Δt=uΔt, (21)

where Δt=(Δtₓ,Δt_{y},Δt_{z}) is the time-shift vector, and u=(uₓ,u_{y},u_{z}) is the image wave-field propagation direction defined in equation (7).

In theory, the technique should be applied on common reflection-angle volumes. However, in practice, migrated stacks can be used directly, as they are often assumed to have a zero reflection angle.

The alternative derivation of the angle domain image wave equation (14) noted above is now discussed. In seismic migration, the image may be formed by propagating source and receiver wave-fields and then applying an imaging condition. Commonly, the cross-correlation imaging condition is used as follows:

p_{I}(x;ω)=p_{S}(x;ω)p_{R}^{H}(x;ω), (22)

where p_{I}, p_{S} and p_{R} are the image, source and receiver wave-fields, respectively.

Applying the Laplacian to both sides of equation (22), the following is obtained:

∇²p_{I}=p_{S}∇₂p_{R}^{H}+p_{R}^{H}∇²p_{S}+2∇p_{S}·∇p_{R}^{H}. (23)

Both the source and receiver wave-fields satisfy the wave equation, that is

$$\frac{- {ω}^{2}}{{c}^{2}} {p}_{S} = {∇}^{2} {p}_{S} , \frac{- {ω}^{2}}{{c}^{2}} {p}_{R} = {∇}^{2} {p}_{R} . \qquad ( 24 )$$

Substituting equation (24) into equation (23), the following is obtained:

$${∇}^{2} {p}_{I} = - 2 \frac{{ω}^{2}}{{c}^{2}} {p}_{S} {p}_{R}^{H} + 2 ∇ {p}_{S} \cdot ∇ {p}_{R}^{H} . \qquad ( 25 )$$

Quantity cos(2θ) is defined as

$$cos ( 2 θ ) ≡ \frac{{c}^{2} ∇ {p}_{S} \cdot ∇ {p}_{R}^{H}}{- {ω}^{2} {p}_{S} {p}_{R}^{H}} . \qquad ( 26 )$$

Substituting equations (22) and (26) into equation (25), the following is obtained:

$${∇}^{2} {p}_{I} = - 2 \frac{{ω}^{2}}{{c}^{2}} {p}_{I} - 2 \frac{{ω}^{2}}{{c}^{2}} cos ( 2 θ ) {p}_{I} . \qquad ( 27 )$$

Expanding equation (27) using the double-angle rule results in equation (28) as follows:

$${∇}^{2} {p}_{I} = - 4 \frac{{ω}^{2}}{{c}^{2}} {cos}^{2} ( θ ) {p}_{I} . \qquad ( 28 )$$

Equation (28) can then be written as:

$${∇}^{2} {p}_{I} = \frac{1}{{v}_{θ}^{2}} {\partial }_{t}^{2} {p}_{I} , \\ {v}_{θ} = \frac{1}{2} \frac{c}{cos ( θ )} , \qquad ( 29 )$$

which is consistent with equation (14).

Equation (29) shows that the image p_{I} (imaged seismic data) is a solution of a wave equation. Now, it will be shown that θ in relationship (26) indeed represents the reflection angle.

The source and receiver wave-fields can be viewed as a superposition of plane waves, that is,

p_{S}(x;ω)=∫P_{S}(k_{S};ω)e+i^{k}^{_{S}}.^{x}dk_{S}, p_{R}(x;ω)=∫P_{R}(k_{R};ω)e+ⁱ^{k}^{_{R}}^{.}^{x}′dk_{R}, (30)

where k_{S} and k_{R} are the source and receiver wave-number vectors, respectively.

Substituting equation (30) into equation (26), the following is obtained for θ:

$$cos ( 2 θ ) = \frac{\int i \underline{{k}_{S}} \cdot i \underline{{k}_{R}} {P}_{S} {P}_{R}^{H} {e}^{+ i \underline{{k}_{s}} \cdot \underline{x} - i \underline{ {k}_{R}} \cdot \underline{x}} d \underline{{k}_{S}} d \underline{{k}_{R}}}{( \int \frac{iω}{c} {P}_{S} {e}^{+ i \underline{{k}_{S}} \cdot \underline{x}} d \underline{{k}_{S}} ) ( \int \frac{iω}{c} {P}_{R}^{H} {e}^{- i \underline{{k}_{R}} \cdot \underline{x}} d \underline{{k}_{R}} )} . \qquad ( 31 )$$

Because the source and receiver wave-fields satisfy the wave equation and its dispersion relation, equation (31) can be written as:

$$cos ( 2 θ ) = \frac{\int \underline{{k}_{S}} \cdot \underline{{k}_{R}} {P}_{S} {P}_{R}^{H} {e}^{+ i \underline{{k}_{s}} \cdot \underline{x} - i \underline{ {k}_{R}} \cdot \underline{x}} d \underline{{k}_{S}} d \underline{{k}_{R}}}{\int \vert \underline{{k}_{S}} \vert \vert \underline{{k}_{R}} \vert {P}_{S} {P}_{R}^{H} {e}^{+ i \underline{{k}_{s}} \cdot \underline{x} - i \underline{ {k}_{R}} \cdot \underline{x}} d \underline{{k}_{S}} d \underline{{k}_{R}}} . \qquad ( 32 )$$

For any given source and receiver wave-number vectors, the integrals are dropped, and the equation readily translates to the dot product rule for calculating the angle between two vectors:

$$cos ( 2 θ ) = \frac{\underline{{k}_{S}} \cdot \underline{{k}_{R}}}{\vert {k}_{S} \vert \vert {k}_{R} \vert} . \qquad ( 33 )$$

Equation (33) shows that indeed B in relationship (26) corresponds to the reflection angle.

The eigenvalues and vectors of the Dirac operator can be computed by operating in the wave-number domain. The eigenspace projection operator introduced in equation (14) and the eigenvectors are now defined as follows:

$$σ \cdot ∇ p ≡ ( \begin{matrix}{ik}_{z} & {ik}_{x} + {k}_{y} \\ {ik}_{x} - {k}_{y} & - {ik}_{z}\end{matrix} ) p . \qquad ( 34 )$$

The eigenvalues are given by:

k=±i\sqrt{kₓ²+k_{y}²+k_{z}²}. (35)

The eigenvectors for positive and negative eigenvalues, respectively, are given by:

$${ψ}_{+} = ( \begin{matrix}1 \\ \frac{{ik}_{x} - {k}_{y}}{{ik}_{z} + i \vert k \vert sgn ( {k}_{z} )}\end{matrix} ) , \\ {ψ}_{\_} = ( \begin{matrix}\frac{- {ik}_{x} - {k}_{y}}{{ik}_{z} + i \vert k \vert sgn ( {k}_{z} )} \\ 1\end{matrix} ) . \qquad ( 36 )$$

The signum function sets the sign convention, i.e., the sign of propagation direction is defined by the sign of the depth wave-number k_{z}. Projecting an observed image wave-field onto the eigenvectors is defined by the relation:

$$p ( \underline{x} ) = K [ p ] ≡ \int d \underline{k} {e}^{- i \underline{k} \cdot \underline{x}} \frac{1}{‖ {ψ}_{\pm } ‖} {ψ}_{\pm } ( \underline{k} ) \times p ( \underline{k} ) . \qquad ( 37 )$$

Both eigenvectors can be used in equation (37). The sign of the resulting time-shifts depends on the choice.

Based on the above model and equations, a couple of recorded seismic data sets are processed and the results compared to traditional processing algorithms. 3D displacement shifts for dipping reflectors are now exemplified.

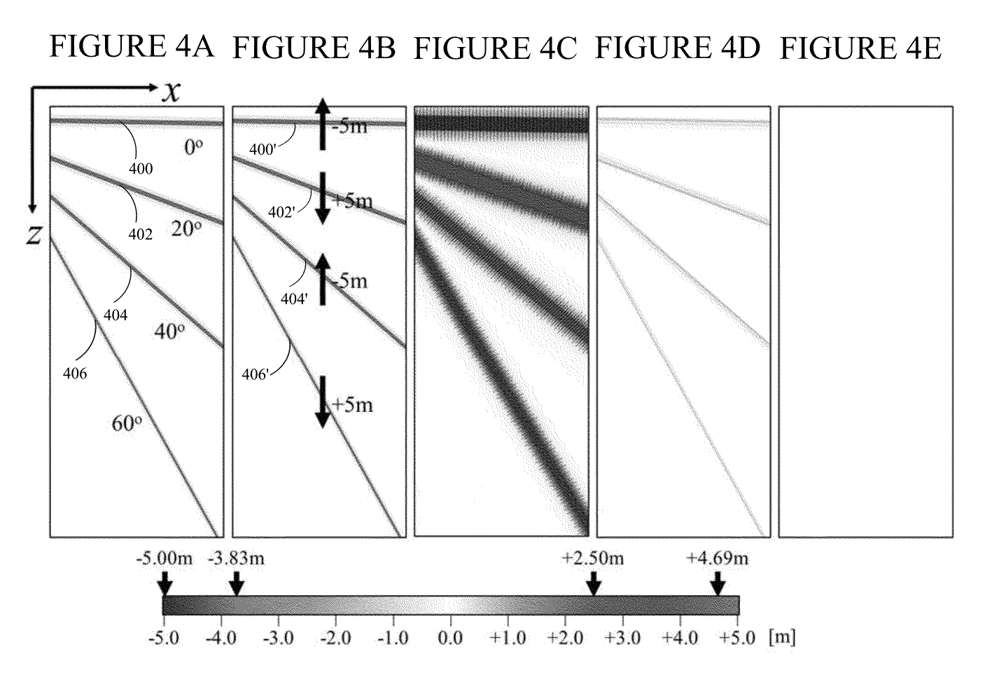

First, the method is applied to a simple synthetic dataset. The image is composed of four dipping reflectors 400 to 406. FIG. 4A shows the base dataset, while FIG. 4B shows the monitor dataset. The monitor dataset has been generated by applying positive and negative 5 m displacements in the vertical direction on the base dataset, thus resulting in four dipping reflectors 400′ to 406′ offset from the base reflectors 400 to 406. Normal displacement is the vertical displacement multiplied by the cosine of the dip angle. FIG. 4C shows estimated normal displacements, which correctly match the theoretical values of +/−5 m cos(dip angle). The normal shifts are correctly estimated by the method and completely remove the difference energy when applied to the input datasets. The orientation of the shifts is calculated using equation (21) as demonstrated by solid black lines in FIG. 4C. FIG. 4D shows the difference between the base and monitor datasets, and FIG. 4E shows the difference after applying the estimated shifts to FIG. 4B.

In the time-warping embodiment, the relative time-shift estimation between datasets was discussed. However, the concepts presented in that embodiment are also applicable to other domains; for example, rather than solving for time-shifts, the methodology may be extended to derive velocity perturbations in the medium from move-out observed on migrated common-image gathers, which can be used to drive tomographic velocity updates. Furthermore, the factorization of the wave-equation has direct applications in RTM imaging and angle generation as discussed above. This formulation allows for calculation of the instantaneous propagation direction, simply by forming inner products of the wave-field with the Pauli matrices.

This embodiment has presented a new approach to image-warping that is based on the physics of seismic imaging. By formulating the problem in the context of wave-fields propagation, displacements are obtained normal to the wavefronts, unlike conventional techniques such as 1D warping. Effectively, the method acts as a wave-field-driven refocusing operation on seismic images; therefore, it is favorable in terms of preserving the true characteristics of the data, such as spectral content and amplitude. The effectiveness of this method has been tested on real and synthetic datasets.

The concept of visualizing the seismic image as a wave-field is applicable to other domains. One domain where the formalism developed above may be applied is the migration process. Thus, the following embodiment addresses this domain. A migrated seismic image represents the spatial variability of the earth's reflectivity. The process of migration effectively rotates the seismic wavelet so that it is normal to the imaged reflectors. In the presence of complex geologies and steep dips, the wavelet, when viewed vertically, is stretched according to the structural dip of the image.

Time-lapse analysis methods that attempt to invert changes observed on the migrated images of base and monitors for velocity and impedance generally assume vertical propagation (1D convolution). In dipping and complex media, this assumption no longer holds, as time-strain changes propagate normal to the reflectors. Thus, there is a need to have a new approach that moves beyond traditional 1D convolution.

The concept of seismic image waves (introduced by Hubral et al., “Seismic image waves,” Geophysical Journal International, 125, 431-442, 1996) is used to define an image wave equation. The wave-field solution of this wave equation can be used to perform kinematic and amplitude inversions of time-lapse data on dipping and complex structures. The method is applicable to pre- and post-stack data and is easily combined with existing time and amplitude inversion methods.

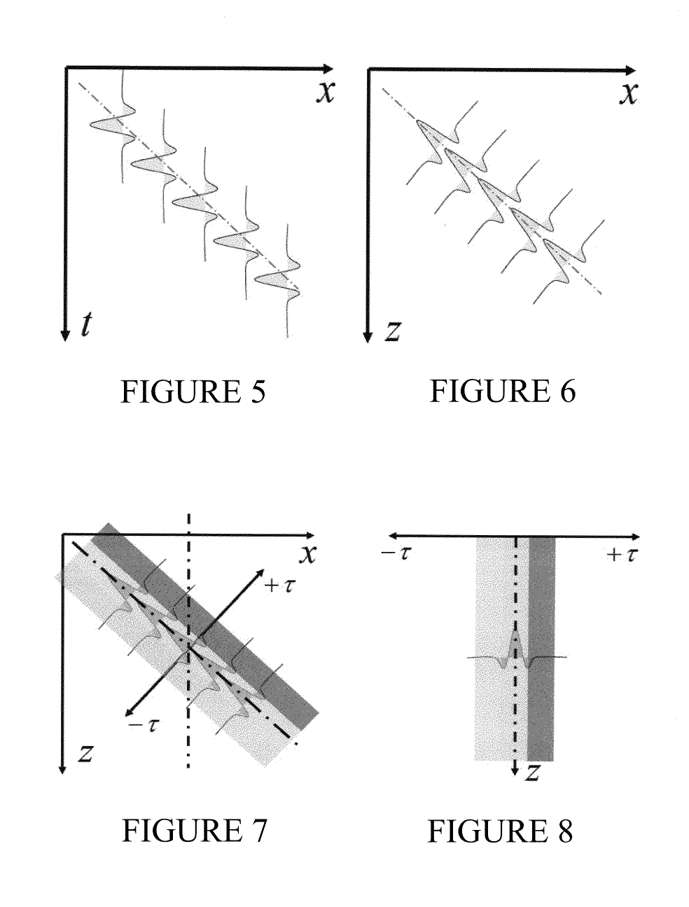

According to this embodiment, seismic data is recorded at the surface of the acquisition survey where amplitude variation with respect to time is measured. Imaging algorithms map the energy recorded on the surface back to the subsurface locations that generated the reflections. The wavelet is then everywhere normal to the reflectors. FIG. 5 schematically shows the wavelets for a simple dipping event before imaging, while FIG. 6 shows the same wavelets after imaging (i.e., after migration). The axes in FIG. 5 are offset in meters and time in seconds, while in FIG. 6 they are offsets in meters and depth in meters. Pre-imaging (FIG. 5), the wavelets are aligned with the time axis, while post-imaging (FIG. 6) they are orthogonal to the reflector, and depth variations are stretched by the dip.

Multiple attempts have been made to remove the effect of this stretch, for example, by applying the shaping operators pre-imaging. More recently, a frequency-wavenumber approach was proposed for modelling and inversion; this method assumes a constant velocity.

From a time-lapse perspective, 4D changes propagate in the direction normal to the reflectors. This limits the applicability of 1D post-imaging methods and points toward pre-imaging approaches such as time-lapse (4D) full waveform inversion (FWI). FWI would be ideal, but it is computationally expensive and difficult to control because it operates on pre-imaging data.

The solution proposed in this embodiment lies midway between the complex pre-imaging and simplistic post-imaging paradigms. This is possible by using the observation that a seismic image (i.e., migrated seismic data) follows a wave equation of the form

$$\frac{1}{{v}^{2} ( \underline{x} )} {\partial }_{τ}^{2} I ( \underline{x} ; τ ) = {∇}^{2} I ( \underline{x} ; τ ) , \\ v ( \underline{x} ) = \frac{1}{2} \frac{c ( \underline{x} )}{cos ( θ )} , \qquad ( 38 )$$

where x=(x,y,z) is the space coordinate vector, τ is a time-like coordinate, c(x) is the velocity of the medium, θ is the reflection angle, and I(x;τ) is the seismic image wave-field associated with this reflection angle, i.e., a common-angle seismic image. Note that equation (38) is similar to equation (14), as both equations are derived based on the same formalism described by equations (7) and (8).

As with any wave equation, a wave-field solution is computed by defining initial and boundary conditions. In this implementation, the zero time of the seismic image wave-field is set to the input seismic image Iₒ(x), i.e.,

I(x;τ=0)=Iₒ(x). (39)

Then, I(x;τ) is solved for an arbitrary range of r using methods such as finite-differences or pseudo-spectral schemes.

The τ axis is also referred to as the “orthogonal time” and has some attributes and/or features that are now discussed. One defining feature of this axis is that it maps back the spectral properties of the imaged seismic data to their pre-imaging nature. This means, that the τ axis removes the wavelet stretch effect due to the structural dip as explained with regard to FIGS. 5-6, for example, by wavelet rotation effect. Another feature of the τ axis is that it can remove the scattering angle related stretch, commonly referred to as migration or NMO stretch.

In isotropic media, these properties are intuitively understood by considering that this extra axis of the wave-field is orthogonal to the wave front (see FIG. 7) of the wave-fields which contain the imaged reflectors as their initial condition, i.e. the wave-fields that encompass the imaged reflectors. For this reason, the name orthogonal time axis is sometimes used instead of the τ axis. Visualising the process in anisotropic media is more difficult as the group and phase velocities of the wave propagation are not in the same direction. One difference between isotropic and anisotropic implementation of the τ axis would be to utilize an anisotropic wave equation, which are known in the art.

If the media is isotropic, the τ axis is orthogonal to the wave front of wave-fields that encompass the imaged reflectors. It therefore captures physical changes in a structurally consistent way. This axis serves as the analysis domain for 4D effects. To emphasize the orthogonality property and to discriminate r from the vertical time t, this axis is referred to as the orthogonal time or the newly created time-axis of the wave-fields. FIG. 7 shows a dipping reflector and the direction of the orthogonal time τ, which is normal to the dipping reflector, while FIG. 8 shows the corresponding gather along the orthogonal time axis. FIG. 7 also shows the wave-fields that encompass the imaged reflector and the τ axis being perpendicular to the wave-front generated by the wave-fields shown in the figure. In one embodiment, the τ axis which defines the propagated wave-fronts that encompass imaged reflectors.

Before turning to 4D analysis, the use of the orthogonal time axis is illustrated in the context of wavelet extraction. Two simple linear events are imaged: one flat and the other dipping by 20°. Both events are convolved with the same wavelet. After imaging, the wavelets are extracted from migrated data, first along the traditional vertical time axis (after depth-to-time conversion of the PSDM image); and second along the orthogonal time axis generated with the proposed method.

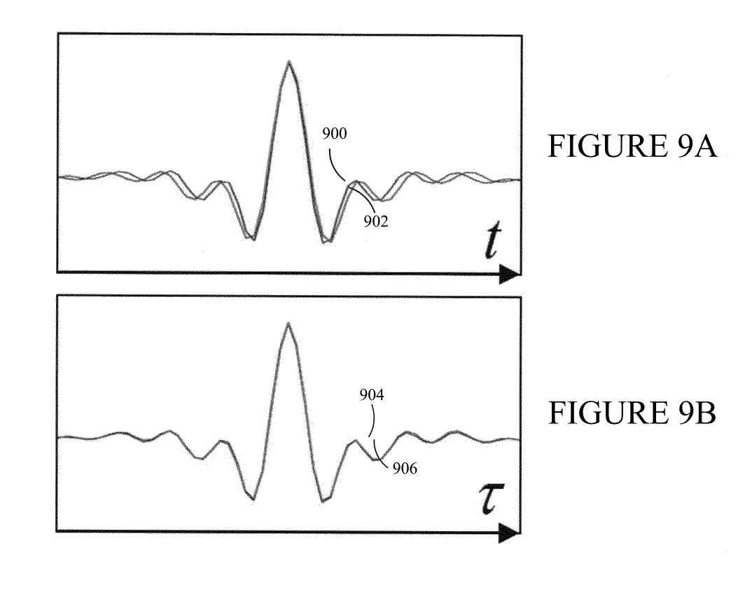

FIGS. 9A and 9B show the four wavelets 900 to 906. FIG. 9A superposes the two wavelets 900 and 902 obtained with the 1D convolutional approach. The extracted wavelets differ since the dip of the structure is not accounted for with this method. This shows that a traditional 1D convolutional inversion with a stationary wavelet is biased by this effect, as it effectively sees the wavelet change with dip. FIG. 9B shows the two wavelets 904 and 906 (flat event and dipping event) extracted along the orthogonal time axis. The two wavelets are the same, showing that inversion along this direction can be done with a single stationary wavelet.

In complex non-flat structures, imaging and reservoir processing algorithms designed to analyze 4D effects have to honor the direction of energy propagation normal to the dips. The wave equation discussed in the previous embodiment, together with the orthogonal time axis, provide an effective way to use existing 4D analysis techniques, pre- or post-stack. The method is relatively simple and fast to implement, cheaper than FWI, and more general than existing stationary techniques in frequency-wavenumber domain.

The concepts of image wave-fields and orthogonal time can be applied to many aspects of seismic data processing. Two of them are now discussed, but those skilled in the art would understand that the invention is not limited to these applications. According to another embodiment, the concept of the image wave-field and orthogonal time can be utilized to estimate and compensate for absorption. This example is not limiting, and different implementations are also applicable.

The absorption (Q) is defined as the loss of energy per unit cycle. One possible mathematical implementation of this concept is as follows:

$$\frac{1}{Q ( ω )} = \frac{- Δ A ( ω )}{2 π A ( ω )} , \qquad ( 40 )$$

where ω is the angular frequency, Q is the absorption coefficient, A is the amplitude of the wave, and ΔA is the amplitude loss per unit cycle.

To simplify the problem, typically the absorption coefficient is assumed to be constant throughout the seismic frequency range. If equation (40) is applied to the image wave-field described by equation (38), the following is obtained:

$$I ( \underline{x} ; τ + Δτ ) = I ( \underline{x} ; τ ) {e}^{- \frac{1}{2 Q ( \underline{x} )} ωΔτ} . \qquad ( 40 )$$

The image wave-field is now spectrally analyzed around each r value, for example, using a windowed Fourier transform or a wavelet transform. The natural logarithm is computed and the relationship is rearranged to give:

$$ln [ \frac{I ( \underline{x} ; τ + Δτ ; ω )}{I ( \underline{x} ; τ ; ω )} ] = - \frac{ωΔτ}{2 Q ( \underline{x} )} . \qquad ( 41 )$$

Equation (41) is linear with respect to spectral amplitude ratios and frequency, with the slope being given by the absorption value Q. A linear regression may now be performed to derive the value of the absorption value Q at each image point, for example:

$$Q ( \underline{x} ) = - {( ln [ \frac{I ( \underline{x} ; τ + Δτ ; ω )}{I ( \underline{x} ; τ ; ω )} ] )}^{- 1} \frac{ωΔτ}{2} . \qquad ( 42 )$$

This relationship may also be used around a subset of image points, assuming that the Q field is smooth.

Compensating for absorption may be performed for each image point. For example, the spectrum E_{Q}(x;ω) of the image wave-field is computed, and amplitudes are balanced according to an effective model that may take the form of:

$${I}_{Q} ( \underline{x} ; ω ) = I ( \underline{x} ; ω ) {E}_{Q} ( \underline{x} ; ω ) , \\ {E}_{Q} ( \underline{x} ; ω ) = \int {e}^{- \frac{ω}{2} \frac{1}{Q ( \underline{x} ) c ( \underline{x} )}} d s , \qquad ( 43 )$$

where the integration follows the ray path.

According to another embodiment, the concepts of image wave-field and orthogonal time are utilized to apply elastic inversion and spectral shaping. This example is not limiting, and different implementations are also applicable. Seismic amplitude variation with offset/angle (AVO/AVA) has been described by Zoeppritz equations. Due to the complexity of the Zoeppritz relationships, several approximations have been introduced to simplify these relationships. One such approximation is the Fatti's three-term approximation, which is given by:

$$\begin{matrix}R ( θ ) = A ( θ ) \frac{Δα}{α} + B ( θ ) \frac{Δβ}{β} + C ( θ ) \frac{Δρ}{ρ} , \\ and & ( 44 ) \\ A ( θ ) = \frac{1}{2} ( 1 + {tan}^{2} θ ) , \\ B ( θ ) = - 4 \frac{β}{α} {sin}^{2} θ , \\ C ( θ ) = \frac{1}{2} ( 1 - 4 \frac{{β}^{2}}{{α}^{2}} {sin}^{2} θ ) , & ( 45 )\end{matrix}$$

where R(θ) is the reflectivity, α, β, and ρ are the elastic parameters, Δα, Δβ, and Δρ are their respective perturbation, and θ is the reflection angle.

Compactly, the process may be written in matrix form as follows:

r=Gm (46)

where

$$r = [ \begin{matrix}R ( {θ}_{1} ) \\ R ( {θ}_{2} ) \\ ⋮ \\ R ( {θ}_{n} )\end{matrix} ] , \\ G = [ \begin{matrix}A ( {θ}_{1} ) & B ( {θ}_{1} ) & C ( {θ}_{1} ) \\ ⋮ & ⋮ & ⋮ \\ A ( {θ}_{n} ) & B ( {θ}_{n} ) & C ( {θ}_{n} )\end{matrix} ] , \\ m = [ \begin{matrix}\frac{Δα}{α} \\ \frac{Δβ}{β} \\ \frac{Δρ}{ρ}\end{matrix} ] . \qquad ( 47 )$$

Before this process can be applied to estimate the elastic parameters, the wavelet has to be de-convolved from the seismic data. The de-convolving may be performed after a depth-to-time conversion of the vertical axis, which is described by:

R(θ;t)=w⁻¹(θ;t)*d(θ;t), (48)

where t=f(z,c(z)) is the 1D depth-to-time converted vertical axis, w⁻¹ is the inverse estimated wavelet, d(θ;t) is the imaged seismic data, and * denotes a convolution operation.

In another embodiment, it is possible to apply the convolution/de-convolution process on the orthogonal time axis r on the image wave-field rather than the traditional vertical axis t (after depth-to-time conversion). That approach results in:

R(θ;x;τ)=w⁻¹(θ;τ)*d(θ;x;τ). (49)

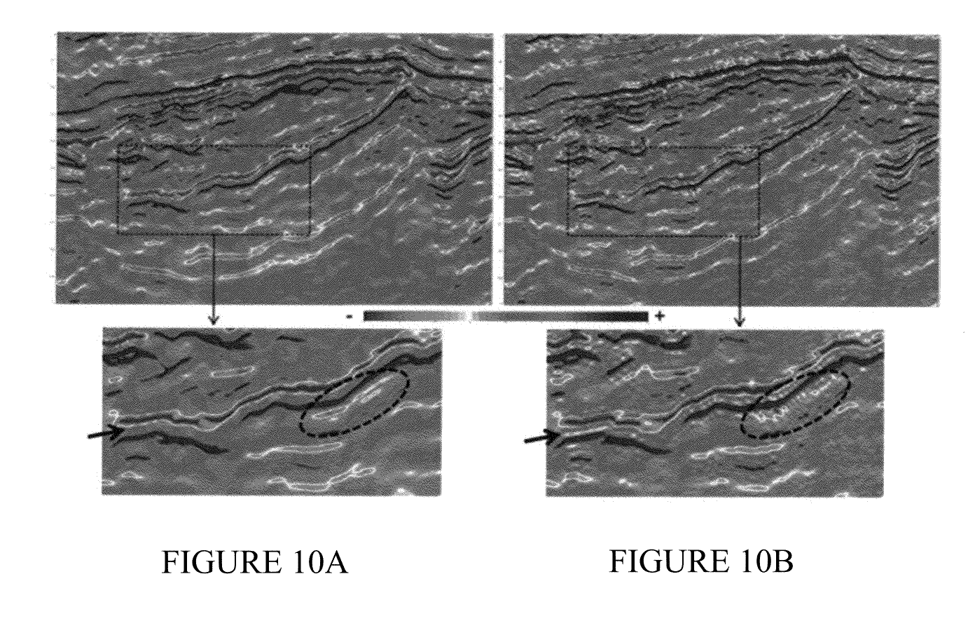

Note that this process is now repeated for each image point along the orthogonal time axis, rather than for each trace. FIGS. 10A-B show a comparison between the traditional elastic inversion (FIG. 10A) and the proposed elastic inversion (FIG. 10B) on a real dataset. The figures show the estimated reflectivity from the two methods. With the method in this embodiment, the inversion is more stable and continuous. Side lobes are also better resolved with the new method. The de-convolution/convolution process is not limited to elastic inversion. Any spectral shaping operation can be applied using the same principle on the orthogonal time axis.

It is also noted that a similar procedure may be applied to derive the wavelet w(θ;τ) from the wavefield. This can be easily done using any of the known methods, for example (Lazear, 1993, Mixed-phase wavelet estimation using fourth-order cumulants, Geophysics, 58). The only difference would be using the orthogonal time axis rather than the traditional vertical time axis.

The next embodiments summarize some of the novel features discussed above and present them as various implementations and/or applications. Those skilled in the art would appreciate that these are only a few of the possible applications of the novel concepts. The above-discussed embodiments can be considered to cover two themes: (i) wave equation-based processing of imaged seismic data, and (ii) seismic imaging using a factorized wave equation.

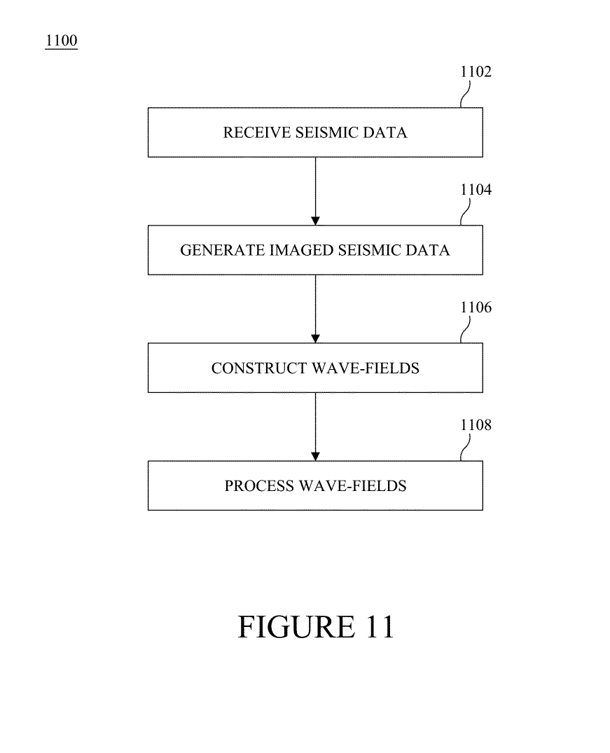

According to the first theme, i.e., wave equation-based processing of imaged seismic data, there is a method 1100, as illustrated in FIG. 11, which receives in step 1102 recorded seismic data d. The recorded seismic data d may be recorded on land, water or combination of the two. A marine seismic acquisition system has been illustrated in FIG. 1. Seismic receivers 122 can include one or more of a hydrophone, geophone, accelerometer, optical sensor or combination thereof. The same is true for land acquisition data. The recorded seismic data d may include one or more sets of seismic data realizations d₁, d₂, . . . . Such realizations are discussed later.

In step 1104, the received seismic data d is partially processed to obtain the imaged seismic data D (D₁, D₂, . . . if the seismic data is d₁, d₂, . . . ). For example, the received seismic data d may be migrated according to known algorithms to obtain the imaged seismic data D. Other seismic processing operations may be applied to obtain the imaged seismic data D. This step is generically called imaging the seismic data.

In step 1106, wave-fields W (or W₁, W₂, . . . if the imaged seismic data is D₁, D₂, . . . ) are constructed or generated for the imaged seismic data D by solving one or more wave equations. The wave equation may be any known wave equation. In one embodiment, the wave equations are given by one of equations (7), (14) or (38). In step 1108, each wave-field W is processed independently or simultaneously along the newly created time-axis of the wave-fields, as discussed, for example with regard to equations (38). These steps are now discussed in more detail.

Imaged seismic data realizations D may include: time-lapse vintages, different seismic acquisitions, common angle/offset/shot/receiver volumes within a single survey, offset classes, and any combination of these elements.

The migration process applied in step 1104 may be any known migration process, for example, RTM. In one embodiment, this processing step may include other algorithms. In still another embodiment, this processing step may include various algorithms except a migration procedure.

The wave equation of step 1106 may incorporate, according to one embodiment, the use of a velocity field, which may be modified according to the nature of the imaged seismic data being processed. For example, the velocity field may be halved and divided by the cosine of the reflection angle as discussed with regard to equation (15).

In one embodiment, the wave equation is the two-way acoustic wave equation (8) after being factorized to its one-way counterpart using the Dirac technique. In another embodiment, the wave equation is the two-way acoustic wave equation (14) after being factorized to its one-way counterpart using a pseudo-spectral method. In still another embodiment, the wave equation is the one-way wave equation derived by decomposing the wave equation into up-going and down-going components.

Step 1108 of processing the wave-fields along the newly created time-axis may include viewing realizations of data as snapshots of a single wave-field, and rearranging the wave equation to compute an attribute of the imaged seismic data realizations. The attribute may be one of: relative time-shift, relative displacement shift, time-strain, velocity perturbation, absorption (Q) difference, etc.

In another embodiment, step 1108 may include viewing each realization of data as a snapshot of its own wave-field, solving the wave equation to compute the full wave-field, and comparing wave-fields of different data realizations at least along the solution axis to extract an attribute of imaged seismic data realizations. The attribute may be one of: relative time-shift, relative displacement shift, time-strain, velocity perturbation, absorption (Q) difference, etc.

In still another embodiment, step 1108 may include viewing a single realization of data as a snapshot of its own wave-field, solving the wave equation to compute the full wave-field, using at least the solution axis to extract a seismic attribute or to apply a processing operation. The seismic attribute may be the absorption (Q) or spectral decay ratio.

Another processing operation may be spectral shaping, e.g., colored inversion or elastic inversion, wavelet estimation or frequency band splitting.

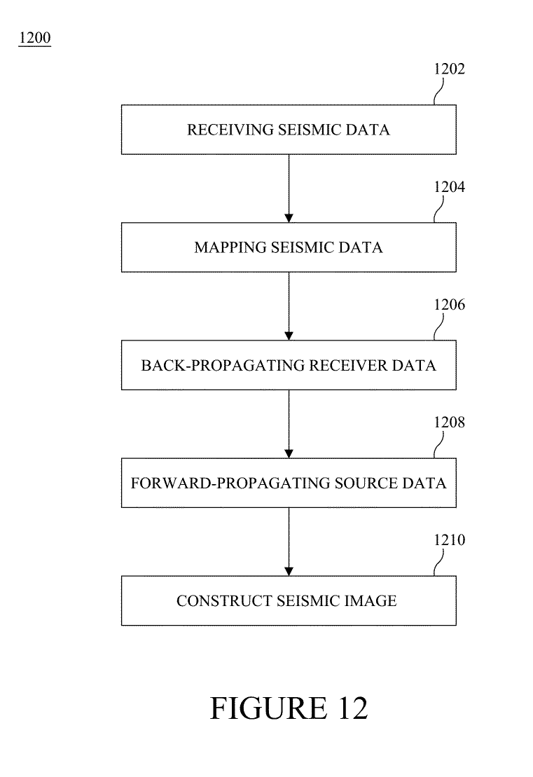

Regarding the second theme, i.e., imaging and processing seismic data by factorizing the wave equation using the Dirac technique, there is a method 1200 illustrated in FIG. 12 that includes a step 1202 of receiving seismic data d, which can be recorded on land or water similar to step 1102 of method 1100. The method further includes a step 1204 of mapping the seismic data d to a multi-component space similar to that of Spinor space of quantum mechanics. In step 1206, the mapped data is back-propagated using a multi-component wave equation, for example, equation (yy). This corresponds to a wave-field that propagates backward in time from the seismic receiver. In step 1208, seismic data that corresponds to a source is forward-propagated, i.e., a corresponding wave-field is forward-propagated using the multi-component wave equation noted above or a different one, for example, equation (14). In step 1210, the forward- and backward-propagated wave-fields are processed together (i.e., applying the imaging condition e.g., by cross-correlation) to construct a seismic image.

The inner products using the Pauli matrices may be used in within the imaging principle to determine the propagation direction and construct angle gathers by computing the relative angles between source and receiver wave-fields or possibly one of the wave-fields and the structural dip angle.

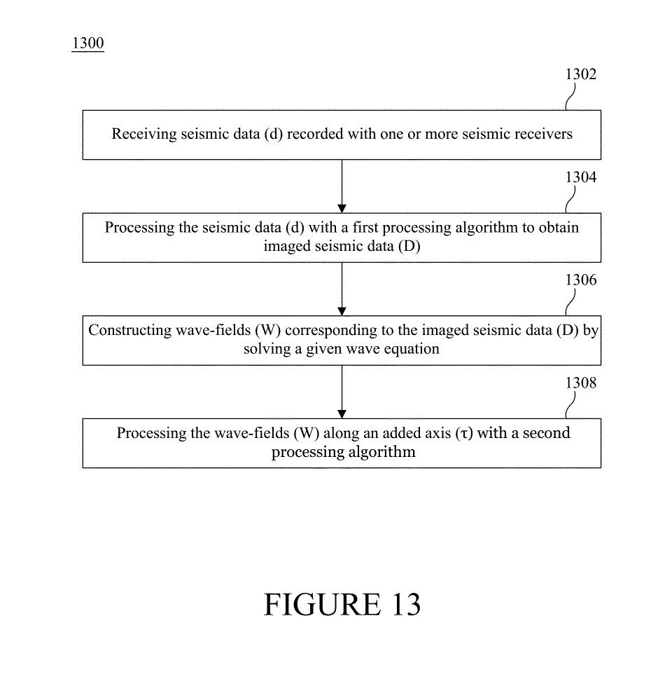

A method for implementing the novel features noted above is now discussed with regard to FIG. 13. According to an exemplary embodiment, there is a method 1300 for processing seismic data associated with a subsurface of the earth. The method includes a step 1302 of receiving seismic data (d) recorded with one or more seismic receivers; a step 1304 of processing the seismic data (d) with a first processing algorithm to obtain imaged seismic data (D); a step 1306 of constructing wave-fields (W) corresponding to the imaged seismic data (D) by solving a given wave equation, wherein the wave-fields (W) have an added axis (τ) which maps back spectral properties of the imaged seismic data to its pre-imaging state; and a step 1308 of processing the wave-fields (W) along an axis (τ) with a second processing algorithm.

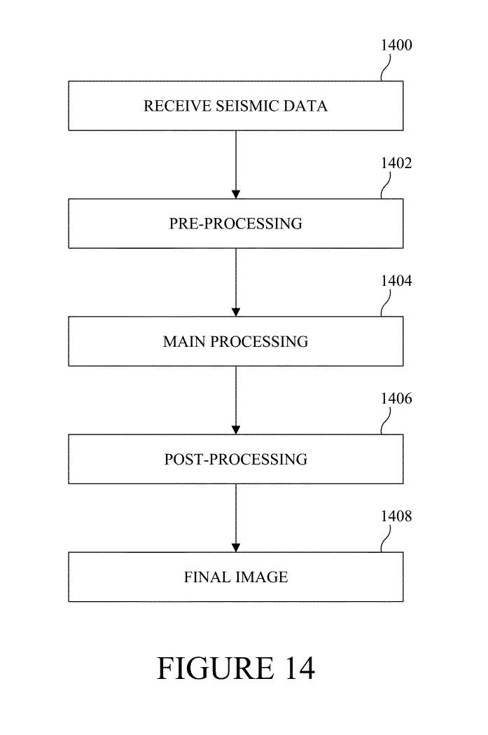

Seismic data as discussed above may be processed in a corresponding processing device for generating an image of the surveyed subsurface as discussed now with regard to FIG. 14. For example, the seismic data collected with the characteristic noted above may be received in step 1400 at the processing device. In step 1402, pre-processing methods are applied, e.g., demultiple, signature deconvolution, trace summing, motion correction, vibroseis correlation, resampling, deblending, etc. In step 1404, the main processing takes place, e.g., deconvolution, amplitude analysis, statics determination, common middle point gathering, velocity analysis, normal move-out correction, muting, trace equalization, stacking, noise rejection, amplitude equalization, etc. In step 1406, final or post-processing methods are applied, e.g., migration, wavelet processing, seismic attribute estimation, inversion, etc., and in step 1408 the final image of the subsurface is generated. Note that at least one process in one of steps 1406 and/or 1408 involves dealing with two or more seismic data sets. Also note that a result of this processing may result in an improvement of the image of the surveyed subsurface and/or increase efficiency in acquiring the seismic data. The improved image quality will result in an increased likelihood of finding the oil and gas reservoirs.

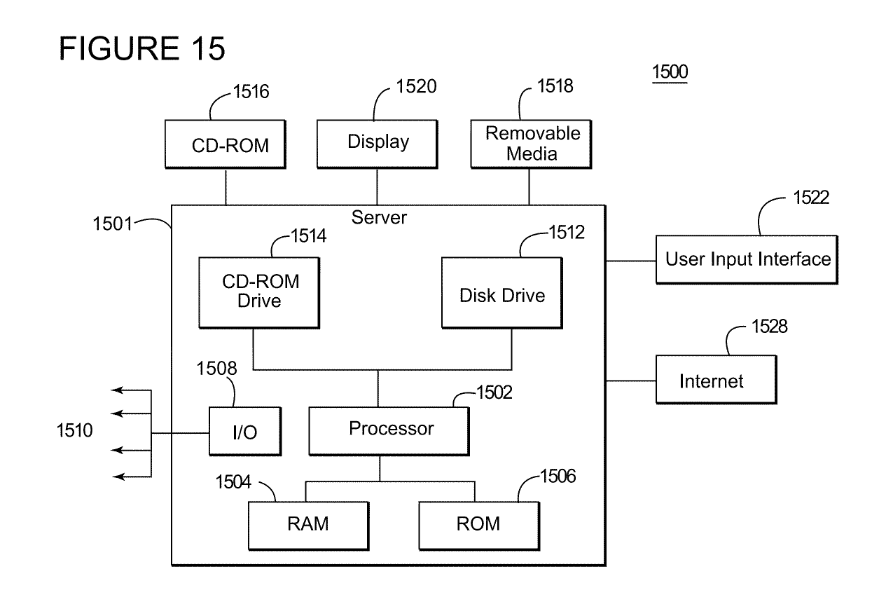

The above method and others may be implemented in a computing system specifically configured to calculate the image of the subsurface. An example of a representative computing system capable of carrying out operations in accordance with the exemplary embodiments is illustrated in FIG. 15. Hardware, firmware, software or a combination thereof may be used to perform the various steps and operations described herein.

The exemplary computing system 1500 suitable for performing the activities described in the exemplary embodiments may include a server 1501. Such a server 1501 may include a central processor (CPU) 1502 coupled to a random access memory (RAM) 1504 and to a read-only memory (ROM) 1506. The ROM 1506 may also be other types of storage media to store programs, such as programmable ROM (PROM), erasable PROM (EPROM), etc. The processor 1502 may communicate with other internal and external components through input/output (I/O) circuitry 1508 and bussing 1510, to provide control signals and the like. The processor 1502 carries out a variety of functions as are known in the art, as dictated by software and/or firmware instructions.

The server 1501 may also include one or more data storage devices, including a hard drive 1512, CD-ROM drives 1514, and other hardware capable of reading and/or storing information such as DVD, etc. In one embodiment, software for carrying out the above-discussed steps may be stored and distributed on a CD- or DVD-ROM 1516, removable memory device 1518 or other form of media capable of portably storing information. These storage media may be inserted into, and read by, devices such as the CD-ROM drive 1514, the disk drive 1512, etc. The server 1501 may be coupled to a display 1520, which may be any type of known display or presentation screen, such as LCD, LED displays, plasma displays, cathode ray tubes (CRT), etc. A user input interface 1522 is provided, including one or more user interface mechanisms such as a mouse, keyboard, microphone, touchpad, touch screen, voice-recognition system, etc.

The server 1501 may be coupled to other computing devices, such as landline and/or wireless terminals via a network. The server may be part of a larger network configuration as in a global area network (GAN) such as the Internet 1528, which allows ultimate connection to various landline and/or mobile client devices. The computing device may be implemented on a vehicle that performs a land seismic survey.

The disclosed exemplary embodiments provide a system and a method for processing recorded seismic data. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for processing seismic data associated with a subsurface of the earth, the method comprising:
receiving seismic data (d) recorded with one or more seismic receivers;
processing the seismic data (d) with a first processing algorithm to obtain imaged seismic data (D);
constructing wave-fields (W) corresponding to the imaged seismic data (D) by solving a given wave equation, wherein the wave-fields (W) have an added axis (τ), which maps back spectral properties of the imaged seismic data to its pre-imaging state; and
processing the wave-fields (W) along the axis (τ) with a second processing algorithm.

2. The method of claim 1, wherein the wave-fields (W) are processed simultaneously.

3. The method of claim 1, wherein the wave-fields (W) are processed independent of each other.

4. The method of claim 1, wherein the first processing algorithm includes migration.

5. The method of claim 1, wherein the second processing algorithm includes at least one of absorption compensation, spectral shaping, deconvolution, general filtering and wavelet estimation.

6. The method of claim 1, wherein the second processing algorithm includes extracting an attribute of the seismic data.

7. The method of claim 6, wherein the attribute includes one of a time-shift, time-strain, displacement-shift, velocity perturbation, and absorption.

8. The method of claim 1, wherein the imaged seismic data (D) corresponds to time-lapse vintages, or different seismic acquisitions, or common angle volumes of a single seismic survey, or common offset volumes of a single seismic survey, or common shot volumes of a single seismic survey, or common receiver volumes of a single seismic survey, or a combination of these elements.

9. The method of claim 1, wherein the given wave equation includes a velocity field that is modified according to the nature of the imaged seismic data.

10. The method of claim 1, further comprising:
mapping realizations of the imaged seismic data (D) to snapshots of a single wave-field (W); and
calculating an attribute associated with the change between realizations of the imaged seismic data.

11. The method of claim 1, further comprising:
mapping each realization of the imaged seismic data (D) to a corresponding snapshot of a single wave-field (W);
solving the given wave equation to compute a full wave-field, wherein the wave-fields (W) has an added axis (τ) which is orthogonal to the wave-fronts that encompass imaged reflectors; and
comparing wave-fields of different realizations of the imaged seismic data along the axis (τ) to extract an attribute associated with the realizations of the imaged seismic data.

12. The method of claim 1, further comprising:
mapping a single realization of the imaged seismic data to a snapshot of a single wave-field (W);
solving the given wave equation to compute a full wave-field, wherein the wave-field (W) have an added axis (τ) which is orthogonal to the wave-fronts that encompass imaged reflectors; and
extracting an attribute associated with the realization of the imaged seismic data by solving the given wave equation and based on the axis (τ).

13. A method for processing seismic data associated with a subsurface of the earth, the method comprising:
receiving imaged seismic data, wherein the imaged seismic data is obtained by processing recorded seismic data (d) with a first processing algorithm;
constructing wave-fields (W) corresponding to the imaged seismic data (D) by solving a given wave equation, wherein the wave-fields (W) have an added axis (τ) which maps back spectral properties of the imaged seismic data to its pre-imaging state; and
processing the wave-fields (W) along the axis (τ).

14. The method of claim 13, wherein the wave-fields (W) are processed simultaneously or independent of each other.

15. The method of claim 13, wherein the first processing algorithm includes migration and the wave-fields (W) are processed using at least one of absorption compensation, spectral shaping, deconvolution, general filtering and wavelet estimation.

16. A computing system for processing seismic data associated with a subsurface of the earth, the computing device comprising:
an interface for receiving seismic data (d) recorded with one or more seismic receivers; and
a processor connected to the interface and configured to,
process the seismic data (d) with a first processing algorithm to obtain imaged seismic data (D),
construct wave-fields (W) corresponding to the imaged seismic data (D) by solving a given wave equation, wherein the wave-fields (W) have an added axis (τ), which maps back spectral properties of the imaged seismic data to its pre-imaging state, and
process the wave-fields (W) along the axis (τ) with a second processing algorithm.

17. The computing device of claim 16, wherein the wave-fields (W) are processed simultaneously.

18. The computing of claim 16, wherein the wave-fields (W) are processed independent of each other.

19. The computing device of claim 16, wherein the first processing algorithm includes migration and the second processing algorithm includes at least one of absorption compensation, spectral shaping, deconvolution, general filtering and wavelet estimation.

20. The computing device of claim 16, wherein the second processing algorithm includes extracting an attribute of the seismic data.
